(19) United States
(12) Patent Application Publication
(10) Pub. No.: US 2002/0101015 A1
(43) Pub. Date: Aug. 1, 2002

(54) Perpendicularly clamping pipe clamp fixture

(76) Inventor: Dana W. Holbrook, San Antonio, TX (US)

Correspondence Address: Dana W. Holbrook, 103 Foxhall Lane, San Antonio, TX, 78213, US

(21) Appl. No.: 09/770,475

(22) Filed: Jan. 29, 2001

(51) Int. Cl. B25B 1/20

(52) U.S. Cl. 269/41

(57) ABSTRACT

A clamping apparatus is disclosed which when used with a threaded pressure plate of a pipe clamp and pipe, can clamp two work piece members of any length in perpendicular directions. The clamping apparatus is a jaw adjustable along the length of the pipe clamp pipe and takes the place of the adjustable pressure plate of the pipe clamp. The jaw clamps along an axis perpendicular to the axis of the pole of the pipe clamp pipe.

### CROSS REFERENCE TO RELATED APPLICATIONS U.S. PATENT DOCUMENTS

U.S. Pat. No. 242,959 June/1881 Naglee . . . 269/156

U.S. Pat. No. 2,606,583 August/1952 O'Connor . . . 269/41

U.S. Pat. No. 4,165,869 August/1979 Williams . . . 269/154

U.S. Pat. No. 4,281,826 August/1981 Calvert . . . 269/246

The above patent documents all relate to clamps which hold members perpendicularly.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The Perpendicularly Clamping Pipe Clamp Fixture is related to clamping assemblies and more particularly wood-working clamps.

The use of clamping assemblies is known in the prior art. Clamping assemblies devised and utilized prior to now consist of familiar and obvious structural configurations in order to accomplish countless objectives and requirements. One of these objectives is perpendicular clamping. The above-cited references involve clamping assemblies which clamp members perpendicularly.

All previous perpendicularly clamping inventions are used to combine work piece members perpendicularly on a scale suitable for the workshop, for example, when assembling furniture. The present invention will allow the craftsman to combine work pieces in the workshop and at the work site, for example to assemble the frame of a house being constructed. At present, framing is accomplished with various crude methods involving several workmen and foot pressure.

Well known in the art is an existing tool commonly known as the pipe clamp. The pipe clamp is commonly composed of three elements, namely: (1) a pipe of varying diameter which is threaded on one end to accept (2) a threaded pressure plate mounted with an adjustable screw and (3) an opposing adjustable pressure plate mounted to the pipe with a set of binding plates and spring to set the plates in such a fashion as to stop and hold the pressure plate in an infinite number of positions along the length of the pipe. The purpose of the pipe clamp is to allow work pieces to be held in place during some form of securing operation. The pipe clamp is very useful in assembling work pieces end to end. The pipe clamp does not, in most instances, effectively allow the work pieces to be held in perpendicular fashion to one another.

The present invention provides a solution to the problem of assembling work pieces in a perpendicular fashion, using the common pipe clamp. Even though perpendicular clamps of varying structures and designs exist in the art, none utilize the pipe clamp to another extent nor work in such a convenient fashion.

### SUMMARY OF THE INVENTION

The Perpendicularly Clamping Pipe Clamp Fixture is a clamp to be used alongside the standard pipe clamp to assemble work pieces which include framing boards, metal construction members and other types of materials.

The Perpendicularly Clamping Pipe Clamp Fixture is a jaw that can be exchanged for the adjustable pressure plate of the standard pipe clamp. The jaw adjusts along the length of the pipe clamp to secure work pieces to be assembled in a perpendicular fashion. The pipe clamp fixture is secured in place along the length of the pipe by a set of spring set binders, just as the adjustable pressure plate of the pipe clamp was. Twin floating pressure plates extend down from the body of the present invention to secure the work piece in place.

This invention would be an asset to the carpenter, welder, or any other tradesman whose work requires holding members in a perpendicular fashion. The framing carpenter would utilize this device in securing stud to plate, securing joist to beam, securing fascia to rafter, etc.

Framing is currently accomplished in many different ways. This tool can be used as an improvement to the framing process. As construction of the house frame proceeds, the perpendicular clamping end will allow the tradesman to clamp framing boards together as the frame is being put together.

In today's construction environment with lumber quality being relatively poor, a tradesman encounters considerable difficulty when trying to achieve a level of craftsmanship he or she is satisfied with. This tool will be of use to accomplish this. For example, in the instance of a framing carpenter attempting to draw a warped plate to a stud for securing a tight fit, this tool is superior. Another example is a carpenter on a ladder securing a joist to a strongback. He encounters a difficult time holding the work piece and securing it at the same time. This tool will facilitate that effort. It will be a time saver and labor saver as it allows one person to accomplish a feat many times requiring more than one person.

This device is also superior to others performing similar function in that it is a component of another tool that most who would use it already own.

This device can be constructed in a multitude of different sizes for different applications, and of differing materials if a manufacturer were to choose to do so.

### BRIEF DESCRIPTION OF THE DRAWINGS

The invention will be better understood when consideration is given to the following detailed description thereof. Such description makes reference to the annexed drawings wherein:

FIG. 1 is a front view of the new Perpendicularly Clamping Pipe Clamp Accessory.

FIG. 2 is a rear view of the present invention.

FIG. 3 is an oblique view of the present invention.

FIG. 4 is a side view illustrating the coupling of the work pieces.

### DETAILED DESCRIPTION OF THE INVENTION

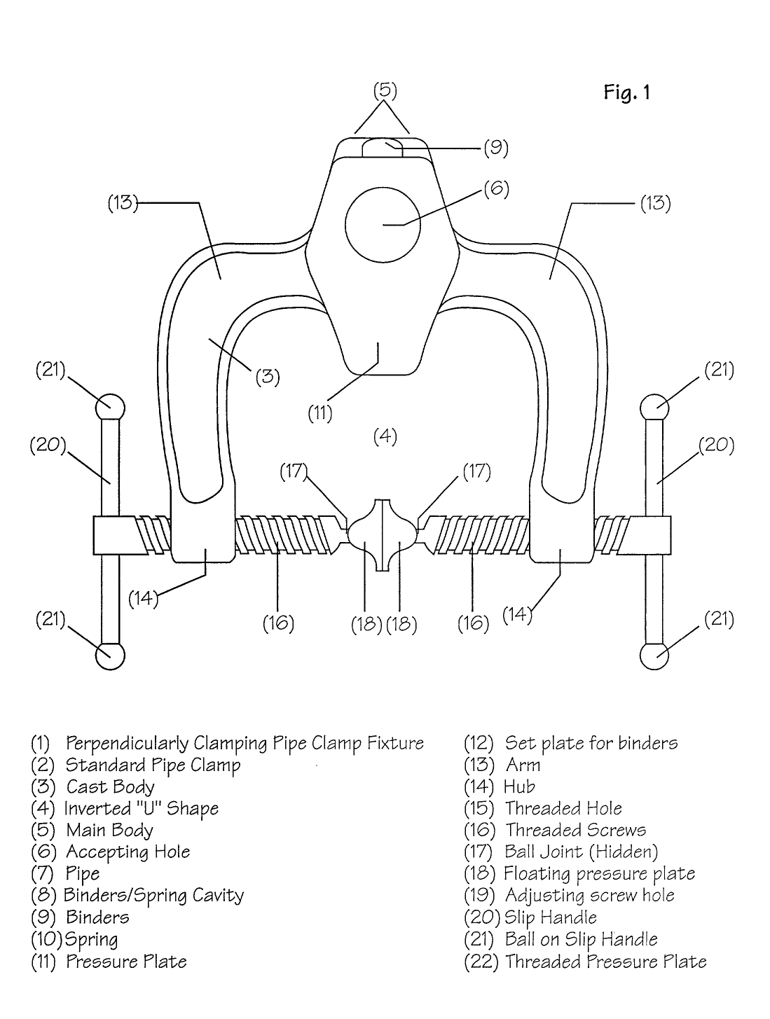

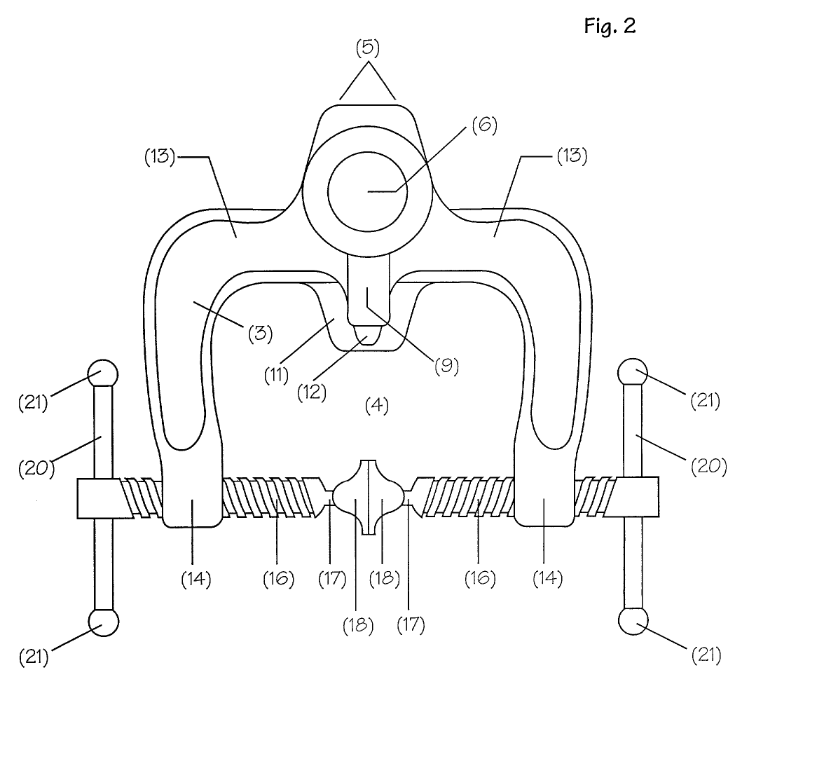

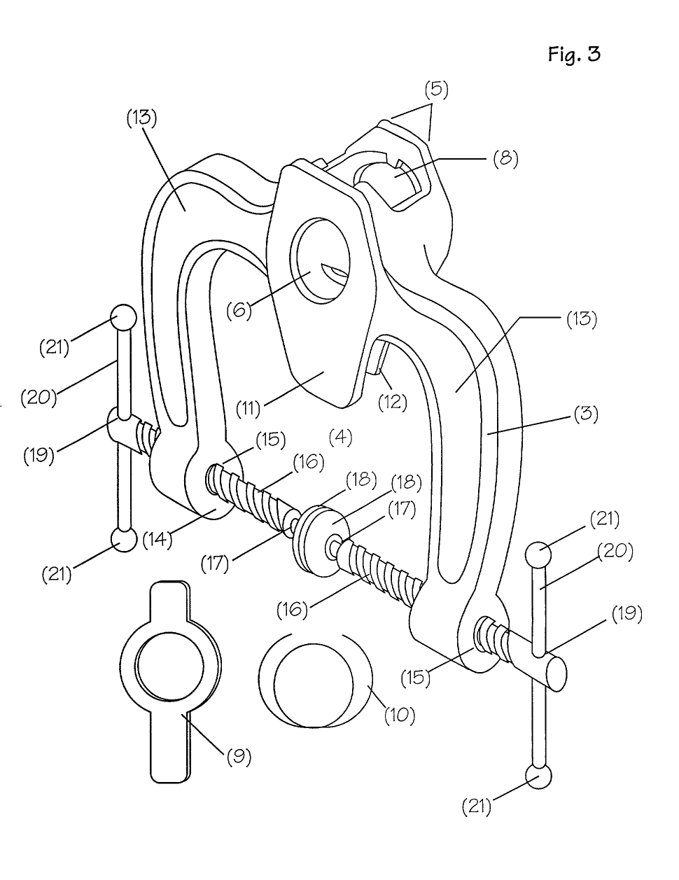

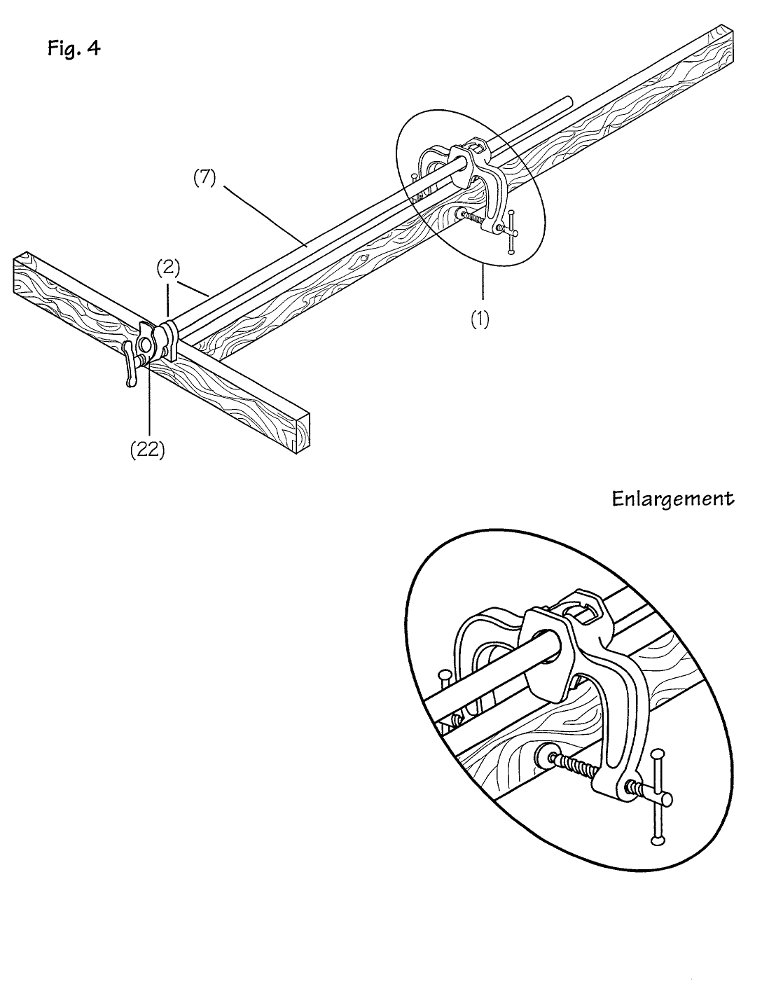

Please refer to the drawings, FIGS. 1 through 4 thereof, a new Perpendicularly Clamping Pipe Clamp Fixture which allows the standard pipe clamp to perform the necessary perpendicular clamping function.

The Perpendicularly Clamping Pipe Clamp Fixture (1) is a cast or forged body (3) forming an inverted “U” shape (4). The upper center portion of the cast body (3) is a main body (5) through which and accepting hole (6) is formed to accept the pipe (7) of the standard pipe clamp (2). Surrounding this hole (6) is a cavity (8) in which four firm (preferably steel) binders (9) and a spring (10) are set, and the pipe (7) is inserted through, to allow the fixture (1) to move freely and be bound in an infinite number of positions along the length of the pipe (7). The front portion of the main body (5) including the hole (6) to accept the pipe (7) is slightly protruded from the rest of the cast body (3). This protruded area forms a pressure plate (11) to facilitate the normal clamping function of the standard pipe clamp (2). On a rear lower portion of the main body (5), just below the accepting hole (6) for the pipe (7), is a small flat area formed into a set plate for the binders (12) to stop the binders (9) in a position to free the fixture (1) from a bound position when pressure is applied. Extending out from the main body (5) in opposite directions and at right angles to the accepting hole (6), are two arms (13) which then, after a short distance turn down and each end in a hub (14). Each hub (14) has a threaded hole (15) also running at a right angle to the accepting hole (6). This configuration forms the inverted “U” shape (4) and completes the cast body (3) portion of the Perpendicularly Clamping Pipe Clamp Fixture (1).

The Perpendicularly Clamping Pipe Clamp Fixture (1) then continues with two threaded screws (16) inserted through the threaded holes (15) in each of the hubs (14) at the base of the cast body (3). These screws (16) have a ball joint (17) on one end facing the interior of the cast body (3) on which a floating pressure plate (18) is mounted. These pressure plates (18) oppose each other and can be adjusted towards each other or away from each other by turning the screws (16). The screws (16) have a hole (19) on the opposite end of the ball joint (17) on the outside of the cast body (3) in which a slip handle (20) is placed. These slip handles (20) have a forged ball (21) on each end to keep them from sliding out of the hole (19) in the screw (16). These slip handles (20) facilitate the turning of the screws (16) by force of hand.

The Perpendicularly Clamping Pipe Clamp Fixture (1) consists of some twelve parts which when assembled together complete the fixture (1). These twelve parts are cast body (3), two screws (16), two floating pressure plates (18), two slip handles (20), four firm binders (9) and one spring (10).

The purpose of the standard pipe clamp (2) is to hold work pieces in place during some form of securing operation. The standard pipe clamp (2) does not, in most instances, facilitate or effectively allow work pieces to be held in perpendicular fashion to one another. The Perpendicularly Clamping Pipe Clamp Fixture (1) in conjunction with the standard pipe clamp (2) facilitates this important function.

The function of perpendicular clamping is accomplished by the Perpendicularly Clamping Pipe Clamp Fixture as follows: Remove the existing adjustable pressure plate from the standard pipe clamp (2) and insert the new invention (1). The pipe (7) is inserted through the accepting hole (6) of the new invention (1). The new invention (1) is then held in place and adjusted along the length of the pipe (7) using the binders (9) and spring (10) mounted in the cavity (8) surrounding the accepting hole (6). The arms (13) extending from the main body (5) of the new invention (1) forming the “U” shape (4) are then placed over and around the work piece. The screws (16) are then tightened onto opposing sides of the work piece effectively holding the work piece in parallel alignment with the pipe (7). Another work piece running perpendicular to said work piece is then drawn to and held in perpendicular fashion to said work piece by tightening the threaded pressure plate (22) on the opposite end of the pipe clamp (2).

The Perpendicular Pipe Clamp Fixture (1) may be used alone as a common “C” clamp. The fixture (1) may be used as a common adjustable pressure plate opposing a threaded pressure plate (22) on the standard pipe clamp (2) or it may be used in conjunction with the standard pipe clamp (2) as a means of holding work pieces in perpendicular fashion.

1. I claim as my invention a clamping apparatus which is adjustable along the length of a standard pipe clamp comprising:
a. A body plate with accepting hole for the pipe of the pipe clamp which allows the invention to adjust by moving along the length of the pipe; and
b. A first clamping means having an end plate attached to adjustable screw mounted on said body portion; and
c. A second clamping means having and end plate attached to adjustable screw mounted on said body portion
wherein a vertical work piece (or work piece parallel with the pipe of the pipe clamp) can be clamped in the jaw formed by the closing of the two end plates to exert force against the foot of the work piece perpendicular to a horizontal work piece attached to the fixed movable jaw of the pipe clamp threaded pressure plate.

2. I claim as my invention a new “C” clamp formed in the manner outlined in claim 1.

3. I claim as my invention a new adjustable pressure plate formed in the manner as outlined in claim 1 for pipe clamp utility.
